(19) United States
(12) Patent Application Publication
(10) Pub. No.: US 2022/0166835 A1
(43) Pub. Date: May 26, 2022

(54) MANAGEMENT APPARATUS, RECORDING MEDIUM, AND MANAGEMENT METHOD

(71) Applicant: Motohiro NAGAO, Tokyo (JP)

(72) Inventor: Motohiro NAGAO, Tokyo (JP)

(73) Assignee: Ricoh Company, Ltd., Tokyo (JP)

(21) Appl. No.: 17/455,297

(22) Filed: Nov. 17, 2021

(30) Foreign Application Priority Data
Nov. 25, 2020 (JP) 2020-194965

(51) Int. Cl. H04L 29/08; G16Y 40/10; G16Y 40/40; G16Y 20/10; H04L 12/24

(52) U.S. Cl. CPC H04L 67/12; G16Y 40/10; H04L 41/12; G16Y 20/10; G16Y 40/40

(57) ABSTRACT

A management apparatus includes a memory, and a processor coupled to the memory and configured to calculate position information of a device based on a distance measurement result with respect to the device, and determine a worker who is to be responsible for the device based on position information of the worker and the calculated position information of the device. The distance measurement result is measured by each of three or more network devices that communicate with the device, and the position information of the worker is received from a terminal device that is assigned to the worker.

### CROSS-REFERENCE TO RELATED APPLICATIONS

The present application claims priority under 35 U.S.C. § 119 to Japanese Patent Application No. 2020-194965, filed on Nov. 25, 2020, the entire contents of which are incorporated herein by reference.

### BACKGROUND OF THE INVENTION

### 1. Field of the Invention

The disclosures herein relate to a management apparatus, a recording medium, and a management method.

### 2. Description of the Related Art

There are various devices that are connectable to networks, such as multifunction peripherals (MFPs), office devices, industrial devices, and medical devices. Further, a technology that controls the status of a physical object that is not connectable to a network by attaching a sensor to the object is known (the Internet of Things (IoT)). Management systems that utilize such a device and technology to remotely control the device is already known.

In the related-art, there is known a method for identifying a technician to be dispatched to a device if a failure occurs in the device. Specifically, with this method, the technician is identified by calculating the time required for the technician to move to the device based on the current position of the technician, a movement method, and the installation position of the device (see Patent Document 1, for example).

For a device installed in an office, the installation position of the device may be changed due to various factors such as a layout change. However, even if the actual installation position of the device is changed, position information of the device registered in, for example, a device management apparatus may often remain unchanged. If the registered position information of the device differs from the actual installation position of the device, there is a problem in that a worker who is to be responsible for the device cannot be determined based on the actual installation position of the device. The method described in Patent Document 1 does not solve the above-described problem.

### RELATED-ART DOCUMENTS

### Patent Documents

Patent Document 1: Japanese Unexamined Patent Application Publication No. 2019-70923

### SUMMARY OF THE INVENTION

According to an embodiment of the present invention, a management apparatus includes a memory, and a processor coupled to the memory and configured to calculate position information of a device based on a distance measurement result with respect to the device, and determine a worker who is to be responsible for the device based on position information of the worker and the calculated position information of the device. The distance measurement result is measured by each of three or more network devices that communicate with the device, and the position information of the worker is received from a terminal device that is assigned to the worker.

### BRIEF DESCRIPTION OF THE DRAWINGS

Other objects and further features of the present invention will be apparent from the following detailed description when read in conjunction with the accompanying drawings, in which:

FIG. 1 is a diagram illustrating an example configuration of an information processing system according to an embodiment;

FIG. 2 is a diagram illustrating an example hardware configuration of a computer according to the embodiment,

FIG. 3 is an example hardware configuration of a smartphone according to the embodiment;

FIG. 4 is a diagram illustrating an example functional configuration of the information processing system according to the embodiment;

FIG. 5 is a diagram illustrating an example functional configuration of a management apparatus according to the embodiment;

FIG. 6 is a flowchart illustrating an example process performed by the information processing system according to the embodiment;

FIG. 7 is a sequence diagram illustrating an example process constantly performed by the information processing system according to the embodiment;

FIG. 8 is sequence diagram illustrating an example process performed by the information processing system according to the embodiment when a device failure occurs;

FIG. 9A through FIG. 9C are diagrams illustrating example user interfaces of the management system according to the embodiment;

FIG. 10 is a sequence diagram illustrating an example process performed by the information processing system according to the embodiment when a device failure occurs;

FIG. 11 is a sequence diagram illustrating an example process performed by the information processing system according to the embodiment when a device failure occurs;

FIG. 12 is a diagram illustrating an example user interface of the management system according to the embodiment;

FIG. 13 is a diagram illustrating an example process performed by the information processing system according to the embodiment; and

FIG. 14 is a diagram illustrating an example process performed by the information processing system according to the embodiment.

### DESCRIPTION OF THE EMBODIMENTS

It is an object of an embodiment of the present invention to provide a management apparatus that can appropriately determine a worker who is to be responsible for a device based on actual position information of the device.

In the following, embodiments of the present invention will be described with reference to the accompanying drawings.

### First Embodiment

### <System Configuration>

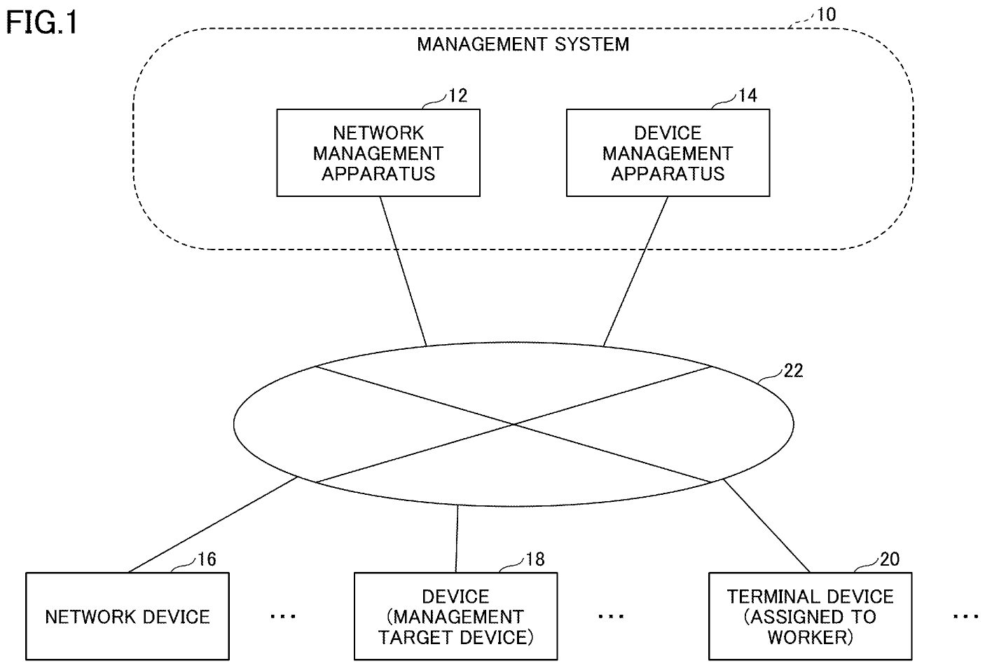

FIG. 1 is a diagram illustrating an example configuration of an information processing system according to an embodiment. The information processing system illustrated in FIG. 1 includes a network management apparatus 12, a device management apparatus 14, three or more network devices 16, one or more management target devices 18 (hereinafter simply referred to as “devices 18”), and one or more terminal devices 20 assigned to workers, which are communicatively connected via a network 22. In the information processing system illustrated in FIG. 1, the network management apparatus 12 and the device management apparatus 14 constitute a management system 10.

The network 22 is a communication network such as a telephone network, the Internet, and a local area network (LAN). The network management apparatus 12 manages the three or more network devices 16. The network management apparatus 12 calculates actual position information of a device 18 by using trilateration with reference network devices 16.

The device management apparatus 14 manages the devices 18. The device management apparatus 14 receives status information from each of the devices 18, and determines whether a failure has occurred in each of the devices 18. For example, if a failure has occurred in a device 18, the device management apparatus 14 determines a worker who is to be responsible for (dispatched to) the device 18 in which the failure has occurred, based on the calculated actual position information of the device 18. For example, the device management apparatus 14 determines a worker who is to be responsible for the device 18 in which the failure has occurred, based on various conditions such as position information of the worker, which is received from a terminal device 20 assigned to the worker, the schedule of the worker, the skill level of the worker, the model of the device 18, and the details (type) of the failure of the device 18. The device management apparatus 14 transmits, to the terminal device 20 of the worker who is to be responsible for the device 18 in which the failure has occurred, an instruction indicating that the worker is to be responsible for the device 18.

It is presumed that the three or more network devices 16, including device MAC addresses and position information (latitudes and longitudes), are registered in the network management apparatus 12, for example. In response to receiving a probe request from a device 18 located in the surroundings of network devices 16, the network devices 16 measure distances from the device 18 that has transmitted the probe request. A method for measuring distances from the device 18 by the network devices 16 is not limited to those using wireless LAN communication. Infrared communication, beacons, RFID, or the like may be used. The network devices 16 provide distance measurement results with respect to the device 18 to the network management apparatus 12 via the network 22.

The devices 18 are target devices managed by the management system 10. The devices 18 may be, for example, facsimiles, MFPs, or other devices for which workers are responsible for performing work. The devices 18 provide status information to the device management apparatus 14 via the network 22.

The terminal devices 20 are information processing terminals that are carried by the workers who may be responsible for performing work for the devices 18, and that can function to detect position information. The terminal devices 20 may be, for example, smartphones. The terminal devices 20 may be head-up display (HUD) devices, industrial machines, network home appliances, mobile phones, tablet terminals, game consoles, personal digital assistants (PDAs), or the like.

The configuration of the information processing system illustrated in FIG. 1 is merely an example. For example, at least some functions of the network management apparatus 12 and the device management apparatus 14 may be implemented by apparatuses other than the network management apparatus 12 and the device management apparatus 14. Also, the functions of the network management apparatus 12 and the device management apparatus 14 may be implemented by a single apparatus such as a management apparatus.

### <Hardware Configuration>

### <<Computer>>

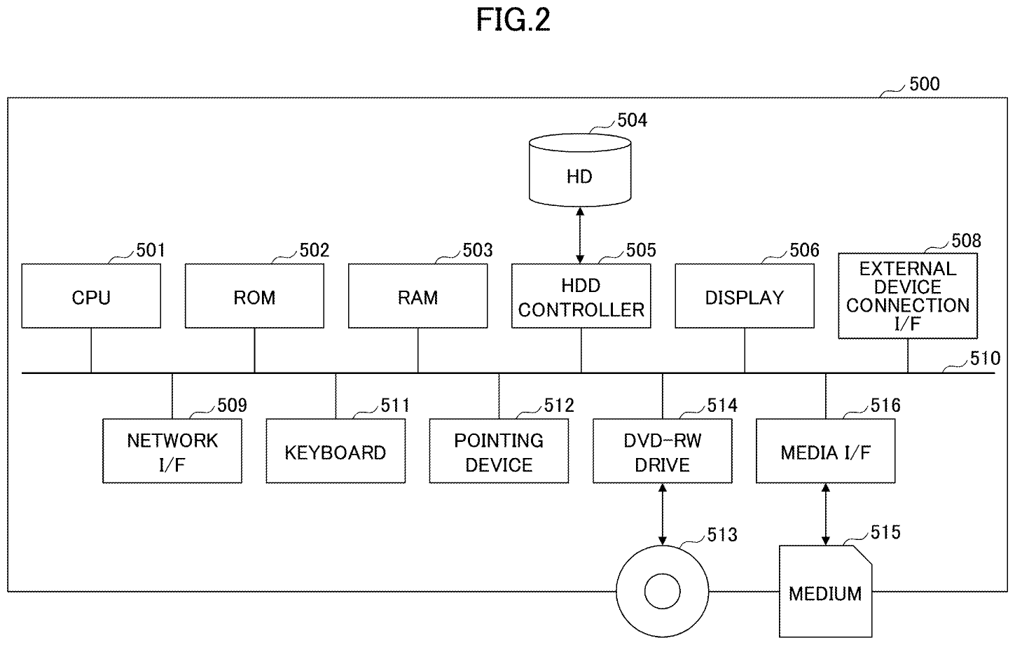

Each of the network management apparatus 12 and the device management apparatus 14 illustrated in FIG. 1 is implemented by, for example, a computer 500 having a hardware configuration as illustrated in FIG. 2. In addition, each of the terminal devices 20 may be implemented by the computer 500 having the hardware configuration as illustrated in FIG. 2. FIG. 2 is a diagram illustrating an example hardware configuration of the computer according to the embodiment.

The computer 500 includes a central processing unit (CPU) 501, a read only memory (ROM) 502, a random access memory (RAM) 503, a hard disk (HD) 504, a hard disk drive (HDD) controller 505, a display 506, an external device connection interface (I/F) 508, a network I/F 509, a data bus 510, a keyboard 511, a pointing device 512, a digital versatile disc rewritable (DVD-RW) drive 514, and a media I/F 516.

The CPU 501 controls the overall operation of the computer 500. The ROM 502 stores a program, such as an initial program loader (IPL), used to drive the CPU 501. The RAM 503 is used as a work area for the CPU 501. The HD 504 stores various types of data such as programs. The HDD controller 505 controls the reading and writing of various types data from and to the HD 504 according to the control of the CPU 501.

The display 506 displays various types of information such as a cursor, menus, windows, characters, and images. The external device connection I/F 508 is an interface for connecting various types of external devices. Examples of the external devices include a universal serial bus (USB) memory. The network I/F 509 is an interface for data communication via the network 22. The data bus 510 is an address bus, a data bus, or the like for electrically connecting the components such as the CPU 501.

The keyboard 511 is a type of an input device having a plurality of keys for inputting characters, numbers, and various types of instructions. The pointing device 512 is a type of an input device that, for example, selects or executes various types of instructions, selects an object to be processed, and moves the cursor. The DVD-RW drive 514 controls the reading and writing of various types of data from and to a DVD-RW 513. The DVD-RW 513 is as an example of a removable recording medium. Note that the DVD-RW 513 is not limited to a DVD-RW, and may be a DVD-R. The media I/F 516 controls the reading and writing (storage) of data from and to (into) a recording medium 515 such as a flash memory.

### <<Smartphone>>

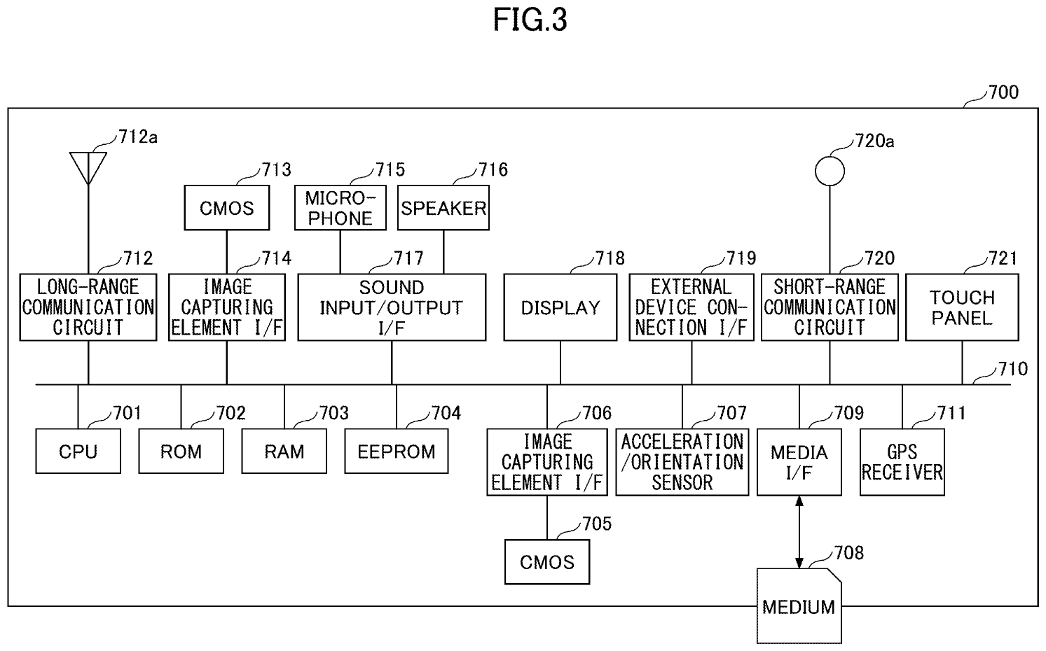

Each of the terminal devices 20 is implemented by, for example, a smartphone 700 having a hardware configuration illustrated in FIG. 3. FIG. 3 is an example hardware configuration of the smartphone according to the embodiment. As illustrated in FIG. 3, the smartphone 700 includes a CPU 701, a ROM 702, a RAM 703, an electrically erasable programmable read-only memory (EEPROM) 704, a complementary metal-oxide semiconductor (CMOS) sensor 705, an image capturing element I/F 706, an acceleration/orientation sensor 707, a media I/F 709, and a GPS receiver 711.

The CPU 701 controls the overall operation of the smartphone 700. The ROM 702 stores programs used to drive the CPU 701 and an IPL for driving the CPU 701. The RAM 703 is used as a work area for the CPU 701. The EEPROM 704 reads and writes various data, such as programs for the smartphone 700, according to the control of the CPU 701.

The CMOS sensor 705 is a type of a built-in imaging unit that captures a subject (mainly an image of a user him/herself) to obtain image data according to the control of the CPU 701. Note that the CMOS sensor 705 may be any other imaging unit such as a charge-coupled device (CCD) sensor, instead of a CMOS sensor. The imaging capturing element I/F 706 is a circuit that controls the driving of the CMOS sensor 705. The acceleration/orientation sensor 707 includes various sensors, such as an electromagnetic compass, a gyrocompass, and an acceleration sensor, for detecting a geomagnetic field.

The media I/F 709 controls the reading and writing (storage) of data from and to a recording medium 708 such as a flash memory. The GPS receiver 711 receives a GPS signal from a GPS satellite.

The smartphone 700 further includes a long-range communication circuit 712, a CMOS sensor 713, an image capturing element I/F 714, a microphone 715, a speaker 716, a sound input/output I/F 717, a display 718, an external device connection I/F 719, a short-range communication circuit 720, an antenna 720a of the short-range communication circuit 720, and a touch panel 721.

The long-range communication circuit 712 is a circuit that communicates with other devices via the network 22. The CMOS sensor 713 is a type of a built-in imaging unit that captures a subject to obtain image data according to the control of the CPU 701. The image capturing element I/F 714 is a circuit that controls the driving of the CMOS sensor 713. The microphone 715 is a built-in circuit that converts sound to an electrical signal. The speaker 716 is a built-in circuit that converts an electrical signal into physical vibrations to produce sounds, such as music and speech.

The sound input/output I/F 717 is a circuit that processes the input and output of a sound signal between the microphone 715 and the speaker 716 according to the control of the CPU 701. The display 718 is a type of a display unit such as a liquid crystal display or an organic electroluminescent (EL) display that displays an image of a subject, various icons, and the like. The external device connection I/F 719 is an interface for connecting various external devices. The short-range communication circuit 720 is a communication circuit such as near-field communication (NFC) or Bluetooth (registered trademark). The touch panel 721 is a type of an input unit for operating the smartphone 700 by a worker pressing the display 718.

The smartphone 700 further includes a bus line 710. The bus line 710 is an address bus, a data bus, or the like for electrically connecting the components such as the CPU 701 illustrated in FIG. 3.

### <Functional Configuration>

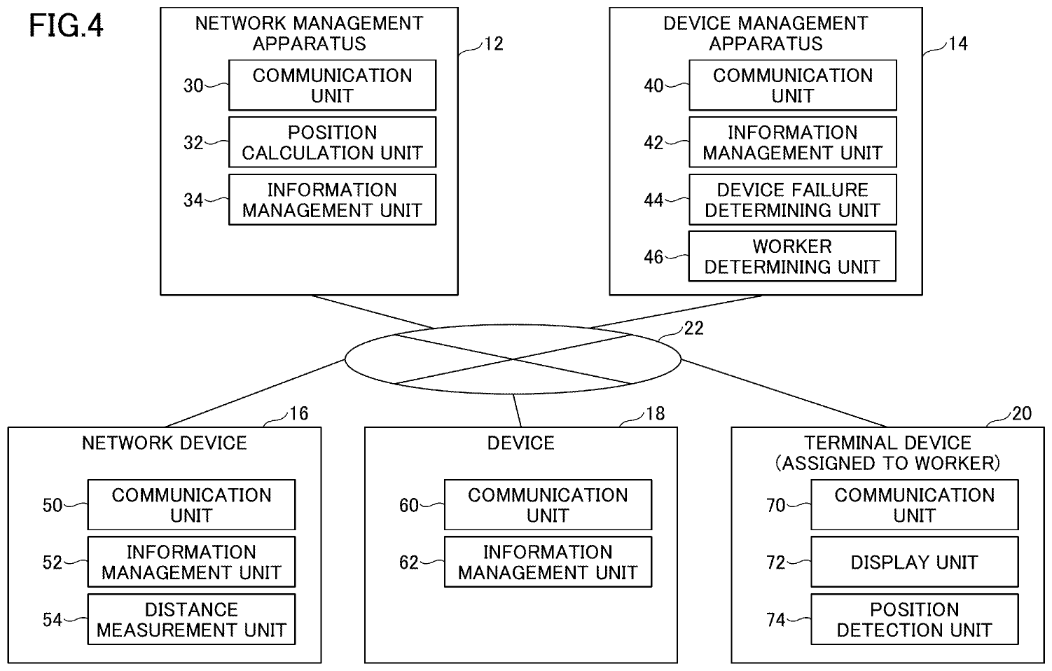

The information processing system according to the embodiment is implemented by, for example, a functional configuration illustrated in FIG. 4. FIG. 4 is a diagram illustrating an example functional configuration of the information processing system according to the embodiment. In FIG. 4, any configuration not necessary for the description of the present embodiment is omitted as appropriate.

The network management apparatus 12 illustrated in FIG. 4 includes a communication unit 30, a position calculation unit 32, and an information management unit 34. The network management apparatus 12 implements the functions illustrated in FIG. 4 by executing a program, for example.

The communication unit 30 communicates with the device management apparatus 14 and the network devices 16. The communication unit 30 receives distance measurement results from the network devices 16. The communication unit 30 transmits position information of the devices 18 to the device management apparatus 14. The communication unit 30 is implemented by a command from the CPU 501, the network I/F 509, and the like illustrated in FIG. 2.

The position calculation unit 32 uses trilateration to calculate actual position information of a device 18, based on position information of reference network devices 16, and the relative distances between the device 18 and the reference network devices 16. The position calculation unit 32 is implemented by the CPU 501 illustrated in FIG. 2 using the RAM 503 as a work area to execute a process according to a program.

The information management unit 34 retains master information such as the device MAC addresses and the position information of the network devices 16. The information management unit 34 is implemented by, for example, a command from the CPU 501, the HDD controller 505, the HD 504, and the like illustrated in FIG. 2.

The device management apparatus 14 illustrated in FIG. 4 includes a communication unit 40, an information management unit 42, device failure determining unit 44, and a worker determining unit 46. The device management apparatus 14 implements the functions illustrated in FIG. 4 by executing a program, for example.

The communication unit 40 communicates with the, network management apparatus 12, the devices 18, and the terminal devices 20. The communication unit 40 receives status information from the devices 18 and the terminal devices 20. If a failure has occurred in a device 18, the communication unit 40 receives position information of the device 18 from the network management apparatus 12. The communication unit 40 transmits, to a terminal device 20 of a worker who is to be responsible for the device 18 in which the failure has occurred, an instruction indicating that the worker is to be responsible for the device 18. The communication unit 40 is implemented by, for example, a command from the CPU 501, the network I/F 509, and the like illustrated in FIG. 2.

The information management unit 42 retains information (identifiers such as IDs, MAC addresses, device numbers, statuses, position information, and the like) on the devices 18, the network devices 16, the terminal devices 20, and the workers of the terminal devices 20. The information management unit 42 is implemented by, for example, a command from the CPU 501, the HDD controller 505, the HD 504, and the like illustrated in FIG. 2.

The device failure determining unit 44 determines whether a failure has occurred in a device 18 based on status information received from the device 18. The device failure determining unit 44 is implemented by the CPU 501 illustrated in FIG. 2 using the RAM 503 as a work area to execute a process according to a program.

The worker determining unit 46 determines a worker who is to be responsible for a device 18 based on actual position information of the device 18 and position information of the worker, as will be described later. The worker determining unit 46 is implemented by the CPU 501 illustrated in FIG. 2 using the RAM 503 as a work area to execute a process according to a program.

As illustrated in FIG. 4, each of the network devices 16 includes a communication unit 50, an information management unit 52, and a distance measurement unit 54. For example, each of the network devices 16 implements the functional configuration as illustrated in FIG. 4 by executing a program.

The communication unit 50 of each of the network devices 16 communicates with the network management apparatus 12 and the devices 18. For example, the network devices 16 may be paths for the devices 18 to connect to the Internet or the like. The information management unit 52 retains information such as a MAC address and a machine number of its corresponding network device 16. The distance measurement unit 54 calculates the distance from a device 18, which is the distance measurement target, based on results of communication with the device 18 (e.g., the time to response, attenuation of the signal strength, and the like).

As illustrated in FIG. 4, each of the devices 18 includes a communication unit 60 and an information management unit 62. Each of the devices 18 implements the functional configuration as illustrated in FIG. 4 by executing a program. The communication unit 60 of each of the devices 18 communicates with the device management apparatus 14 and the network devices 16. The information management unit 62 retains information such as a MAC address and a machine number of its corresponding device 18.

As illustrated in FIG. 4, each of the terminal devices 20 includes a communication unit 70, a display unit 72, and a position detection unit 74. Each of the terminal devices 20 implements the functional configuration as illustrated in FIG. 4 by executing a program.

The communication unit 70 communicates with the device management apparatus 14. For example, the communication unit 70 transmits status information to the device management apparatus 14, and receives an instruction from the device management apparatus 14. The communication unit 70 is implemented by, for example, a command from the CPU 701, the long-range communication circuit 712, and the like illustrated in FIG. 3.

The display unit 72 displays a user interface (UI) for a worker. The display unit 72 is implemented by, for example, a command from the CPU 701, the display 718, and the like illustrated in FIG. 3. The position detection unit 74 uses a position detection function such as a Global Positioning System (GPS) function to detect position information of its corresponding terminal device 20. The position detection unit 74 is implemented by, for example, a command from the CPU 701, the GPS receiver 711, and the like illustrated in FIG. 3.

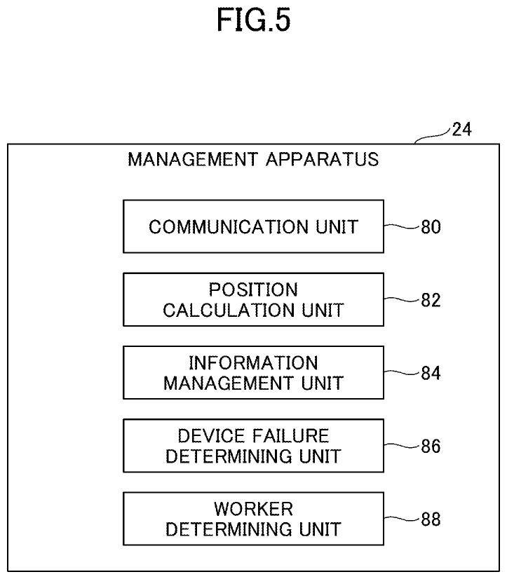

The management system 10 illustrated in FIG. 4 is implemented by the network management apparatus 12 and the device management apparatus 14. However, the management system 10 may be implemented by a management apparatus 24 as illustrated in FIG. 5. FIG. 5 is a diagram illustrating an example functional configuration of the management apparatus according to the embodiment.

The management apparatus 24 illustrated in FIG. 5 includes a communication unit 80, a position calculation unit 82, an information management unit 84, a device failure determining unit 86, and a worker determining unit 88. The management apparatus 24 implements the functional configuration as illustrated in FIG. 5 by executing a program.

The communication unit 80 communicates with the network devices 16, the devices 18, and the terminal devices 20. The communication unit 80 receives distance measurement results from the network devices 16. The communication unit 80 receives status information from the devices 18 and the terminal devices 20. If a failure occurs in a device 18, the communication unit 80 transmits, to a terminal device 20 of a worker who is to be responsible for the device 18, an instruction indicating that the worker is to be responsible for the device 18. The communication unit 80 is implemented by, for example, a command from the CPU 501, the network I/F 509, and the like illustrated in FIG. 2.

The position calculation unit 82 uses trilateration to calculate actual position information of a device 18, based on position information of reference network devices 16 and the relative distances between the device 18 and the reference network devices 16. The position calculation unit 82 is implemented by the CPU 501 illustrated in FIG. 2 using the RAM 503 as a work area to execute a process according to a program.

The information management unit 84 retains information (identifiers such as IDs, MAC addresses, device numbers, statuses, position information, and the like) on the devices 18, the network devices 16, the terminal devices 20, and the workers of the terminal devices 20. The information management unit 84 is implemented by, for example, a command from the CPU 501, the HDD controller 505, the HD 504, and the like illustrated in FIG. 2.

The device failure determining unit 86 determines whether a failure has occurred in a device 18 based on status information received from the device 18. The device failure determining unit 86 is implemented by the CPU 501 illustrated in FIG. 2 using the RAM 503 as a work area to execute a process according to a program.

The worker determining unit 88 determines a worker who is to be responsible for a device 18 based on actual position information of the device 18 and position information of the worker, as will be described later. The worker determining unit 88 is implemented by the CPU 501 illustrated in FIG. 2 using the RAM 503 as a work area to execute a process according to a program.

### <Process>

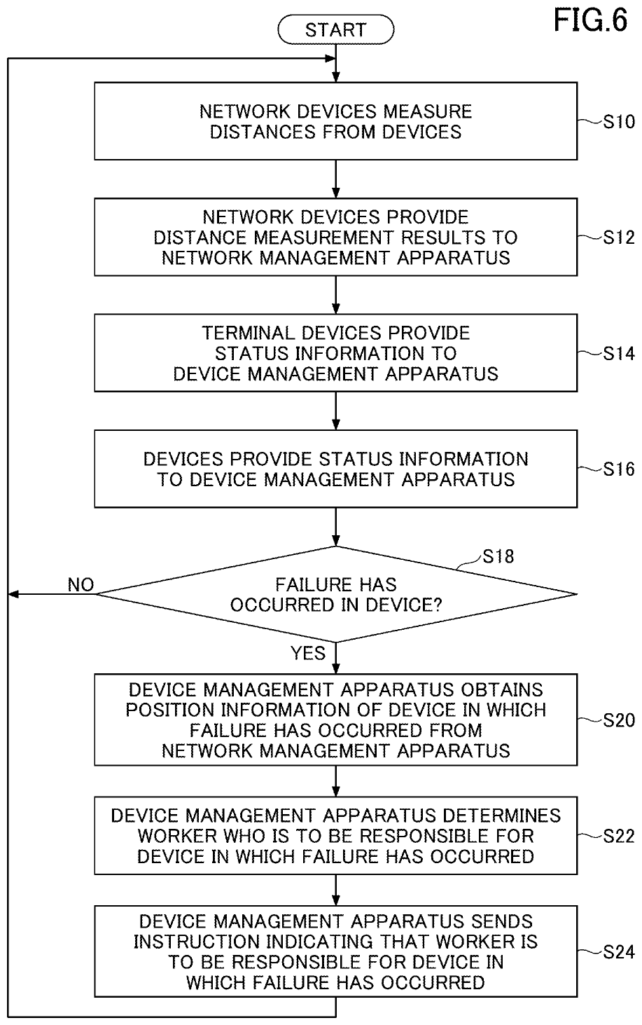

First, an overview of a process performed by the information processing system according to the present embodiment will be described. FIG. 6 is a flowchart illustrating an example process performed by the information processing system according to the embodiment.

Steps S10 through S16 in the process are constantly performed. In step S10, the network devices 16 measure distances from the devices 18. In step S12, the network devices 16 provide distance measurement results to the network management apparatus 12. In step S14, the terminal devices 20 provide status information to the device management apparatus 14. In step S16, the devices 18 provide status information to the device management apparatus 14.

The above-described steps S10 through S16 are repeated until it is determined that a failure has occurred in step S18. In the flowchart illustrated in FIG. 6, when it is determined that a failure has occurred in a device 18, a worker who is to be responsible for the device 18 is determined. However, a worker who is to be responsible for the device 18 may be determined based on any factor other than the failure (for example, at a timing when a periodical inspection is performed).

When it is determined that a failure has occurred in a device 18, the device management apparatus 14 obtains position information of the device 18 in which the failure has occurred from the network management apparatus 12 in step S20. In step S22, the device management apparatus 14 determines a worker who is to be responsible for the device 18 in which the failure has occurred. A worker who is to be responsible for the device 18 in which the failure has occurred is determined based on the actual position information of the device 18 and position information of the worker, as will be described later. Further, a worker who is to be responsible for the device 18 in which the failure has occurred may be determined by taking account into various conditions such as the schedule of the worker, the skill level of the worker, the model of the device 18, and the details (type) of the failure of the device 18, as will be described later.

In step S24, the device management apparatus 14 transmits, to a terminal device 20 assigned to the worker determined in step S22, an instruction indicating that the worker is to be responsible for the device 18 in which the failure has occurred. In response to receiving the instruction, indicating that the worker is to be responsible for the device 18, from the device management apparatus 14, the terminal device 20 displays the instruction on a UI or the like. Accordingly, the worker who is to be responsible for the device 18, in which the failure has occurred, can check the instruction received from the device management apparatus 14 and displayed by the terminal device 20.

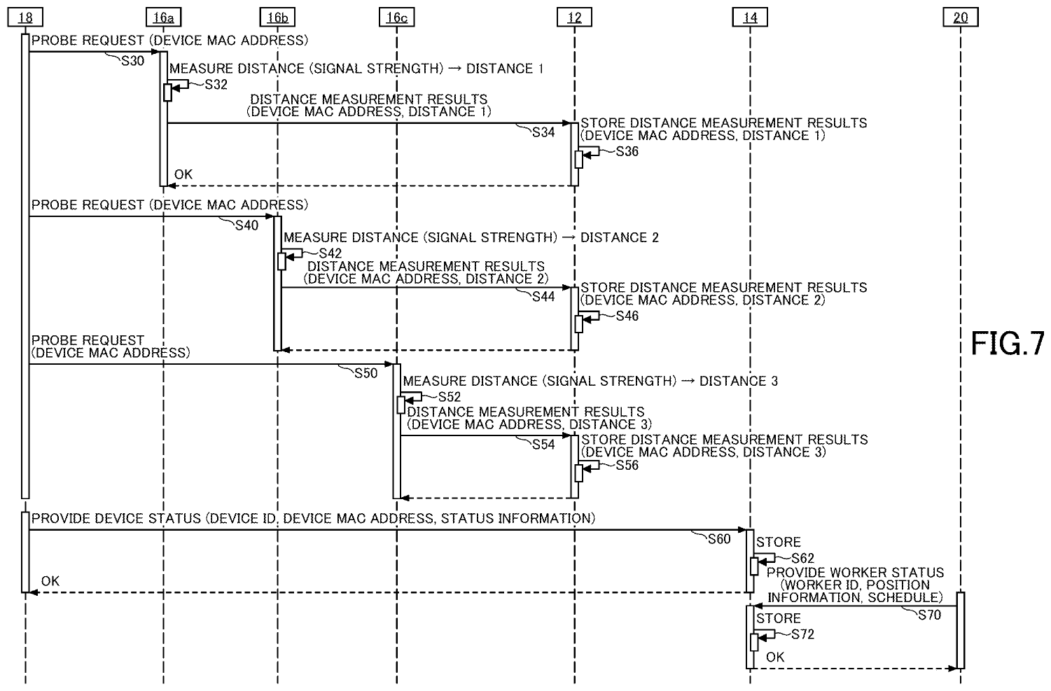

FIG. 7 is a sequence diagram illustrating an example process constantly performed by the information processing system according to the embodiment. The sequence diagram of FIG. 7 depicts an example in which three network devices 16a through 16c measure distances from a device 18. In steps S30, S40, and S50, probe requests are sent from the device 18 in response to beacons received from the network devices 16a through 16c.

In step S30, the device 18 sends a probe request with its MAC address (device MAC address) being specified. In step S32, the network device 16a measures the distance from the device 18 by using, for example, the attenuation of the signal strength of a probe request/response transmitted and received between the network device 16a and the device 18.

In step S34, the network device 16a provides, as distance measurement results, the device MAC address specified in step S30 and the distance from the device 18 measured in step S32 to the network management apparatus 12. In step S36, the network management apparatus 12 stores the distance measurement results provided by the network device 16a.

In step S40, the device 18 sends a probe request with its device MAC address being specified. In step S42, the network device 16b measures the distance from the device 18 by using, for example, the attenuation of the signal strength of a probe request/response transmitted and received between the network device 16b and the device 18.

In step S44, the network device 16b provides, as distance measurement results, the device MAC address specified in step S40 and the distance from the device 18 measured in step S42 to the network management apparatus 12. In step S46, the network management apparatus 12 stores the distance measurement results provided by the network device 16b.

In step S50, the device 18 sends a probe request with its device MAC address being specified. In step S52, the network device 16c measures the distance from the device 18 by using, for example, the attenuation of the signal strength of a probe request/response transmitted and received between the network device 16c and the device 18.

In step S54, the network device 16c provides, as distance measurement results, the device MAC address specified in step S50 and the distance from the device 18 measured in step S52 to the network management apparatus 12. In step S56, the network management apparatus 12 stores the distance measurement results provided by the network device 16c.

In step S30 through S56, the network management apparatus 12 can measure the actual distances between the device 18 and the three network devices 16a through 16c, and store the actual distances and the like as the distance measurement results.

In step S60, the device 18 provides its device ID, the device MAC address, and status information to the device management apparatus 14. In step S62, the device management apparatus 14 associates the status information with the device ID and the device MAC address, all of which are provided by the device 18 14, stores the status information associated with the device ID and the device MAC address.

In step S70, a terminal device 20 provides status information such as a worker ID, position information, and a worker schedule to the device management apparatus 14. In step S72, the device management apparatus 14 associates the status information with the worker ID, all of which are provided by the terminal device 20, and stores the status information associated with the worker ID.

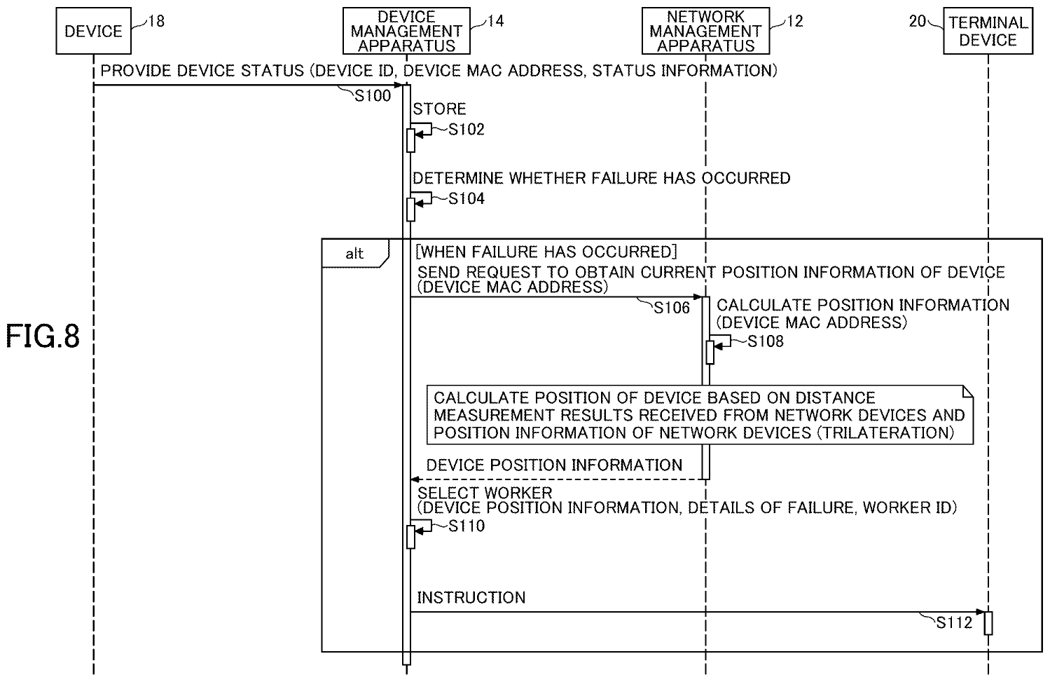

FIG. 8 is sequence diagram illustrating an example process performed by the information processing system according to the embodiment when a device failure occurs. FIG. 8 depicts an example in which a failure has occurred in the device 18.

In step S100, the device 18 provides the device ID, the device MAC address, and status information to the device management apparatus 14. In step S102, the device management apparatus 14 associates the status information with the device ID and the device MAC address, all of which are provided by the device 18, and stores the status information associated with the device ID and the device MAC address.

In step S104, the device management apparatus 14 determines whether a failure has occurred in the device 18 based on the status information provided by the device 18. If the device management apparatus 14 determines that a failure has occurred in the device 18, the device management apparatus 14 sends, together with the device MAC address, a request to obtain position information of the device 18 to the network management apparatus 12 in step S106.

In step S108, the network management apparatus 12 uses trilateration (positioning based on three points) to calculate actual position information of the device 18, based on the distance measurement results received from the network devices 16a through 16c illustrated in FIG. 7 and position information of the network devices 16a through 16c, and sends a response to the device management apparatus 14.

In step S110, the device management apparatus 14 determines (selects) a worker who is to be responsible for the device 18 in which the failure has occurred, based on the actual position information of the device 18 and the position information of the worker (terminal device 20). Note that, in step S110, the device management apparatus 14 may determine the worker by taking into account the details of the failure of the device 18.

In step S112, the device management apparatus 14 transmits, to the terminal device 20 of the worker who is to be responsible for the device 18 in which the failure has occurred, an instruction indicating that the worker is to be responsible for the device 18.

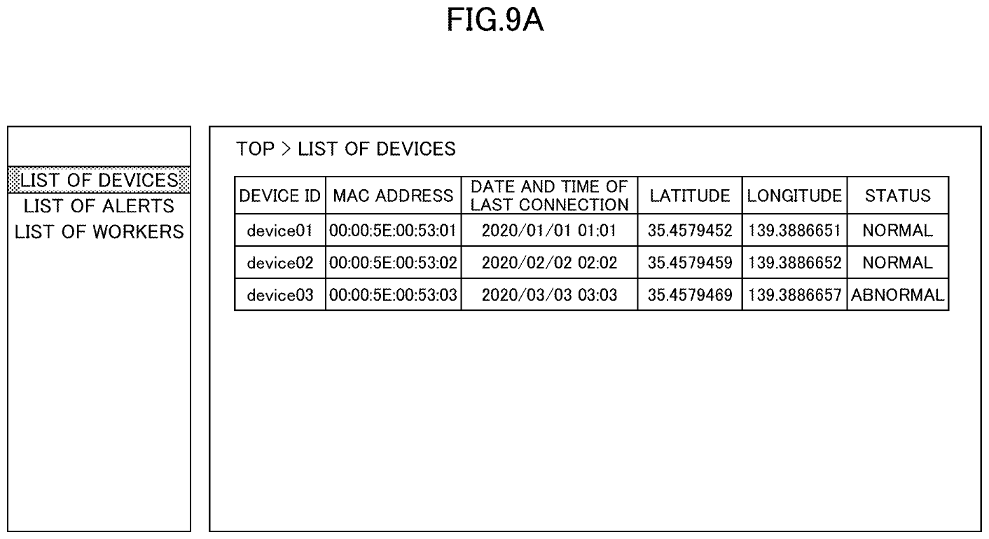

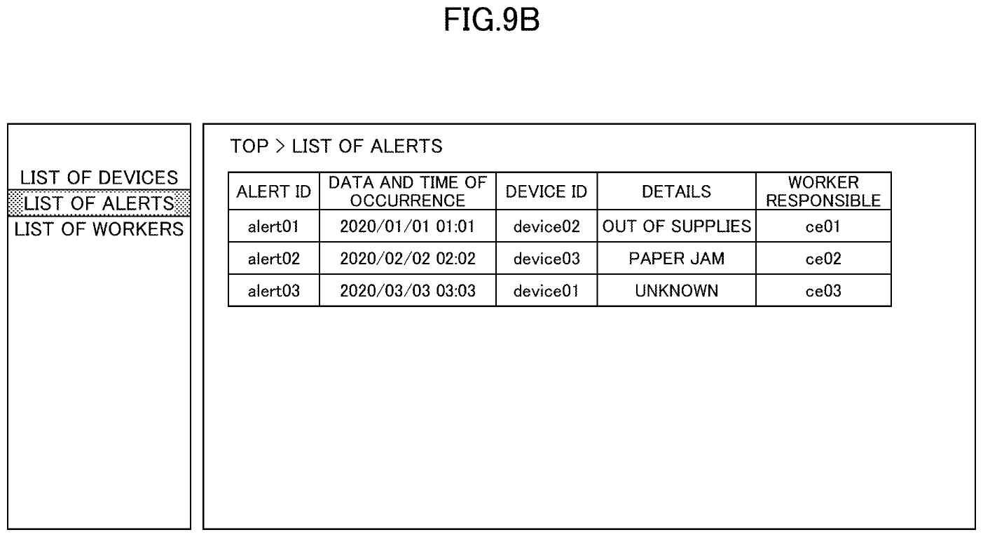

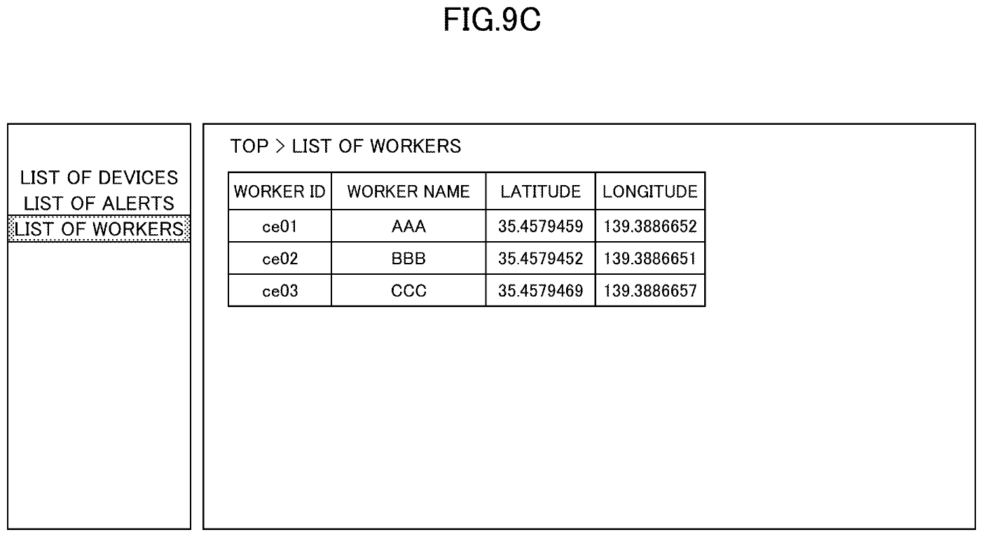

FIG. 9A through FIG. 9C are diagrams illustrating example UIs of the management system according to the embodiment. FIG. 9A is a diagram illustrating an example UI that displays a list of devices. As illustrated in FIG. 9A, actual position information (such as latitudes and longitudes) of devices 18 are stored in association with device IDs and device MAC addresses of the respective devices 18.

FIG. 9B is a diagram illustrating an example UI that displays a list of alerts. As illustrated in FIG. 9B, an alert generated in a device 18 is stored in association with the worker ID of a worker responsible for the device 18. FIG. 9C is a diagram illustrating an example UI that displays a list of workers. As illustrated in FIG. 9C, position information (such as latitudes and longitudes) of workers are stored in association with worker IDs.

The UIs illustrated in FIG. 9A through 9C are merely examples, and any other UIs may be used. For example, if a failure occurs in a device 18, an instruction indicating that a worker is to be responsible for the device 18 may be sent via the UI illustrated in FIG. 9B, a UI dedicated to the worker, or via an email.

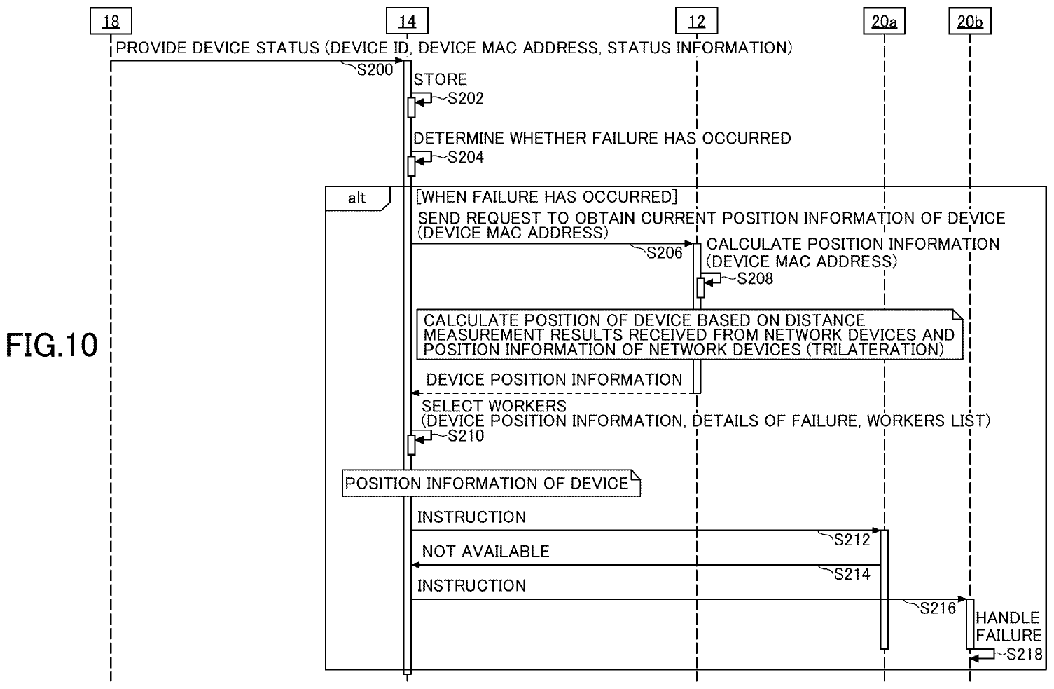

The process illustrated in the sequence diagram of FIG. 8 may be performed as illustrated in a sequence diagram of FIG. 10. FIG. 10 is a sequence diagram illustrating an example process performed by the information processing system according to the embodiment when a device failure occurs.

In step S200, the device 18 provides the device ID, the device MAC address, and status information to the device management apparatus 14. In step S202, the device management apparatus 14 associates the status information with the device ID and the device MAC address, all of which are provided by the device 18, and stores the status information associated with the device ID and the device MAC address.

In step S204, the device management apparatus 14 determines whether a failure has occurred in the device 18 based on the status information provided by the device 18. When the device management apparatus 14 determines that a failure has occurred in the device 18, the device management apparatus 14 sends, together with the device MAC address, a request to obtain position information of the device 18 to the network management apparatus 12 in step S206.

In step S208, the network management apparatus 12 uses trilateration (positioning based on three points) to calculate actual position information of the device 18, based on the distance measurement results received from the network devices 16a through 16c illustrated in FIG. 7 and position information of the network devices 16a through 16c, and sends a response to the device management apparatus 14.

In step S210, the device management apparatus 14 determines (selects) a plurality of workers who are to be responsible for the device 18, in which the failure has occurred, based on the actual position information of the device 18 and position information of the workers (terminal devices 20), sets priorities for the respective workers, and creates a workers list. Note that, in step S210, the device management apparatus 14 may determine a plurality of workers by taking into account the details of the failure that has occurred in the device 18.

In step S212, the device management apparatus 14 transmits, to a terminal device 20a of a worker having the highest priority from among the workers in the workers list, an instruction indicating that the worker is to be responsible for the device 18. In the example of FIG. 10, in step S214, the terminal device 20a of the worker sends, to the device management apparatus 14, a response indicating that the worker is unavailable because the worker is currently responsible for another device 18 or the worker is to be responsible for another device 18.

Therefore, in step S216, the device management apparatus 14 transmits, to a terminal device 20b of a worker having the next highest priority from among the workers in the workers list, an instruction indicating that the worker is to be responsible for the device 18. In step S218, the worker of the terminal device 20b handles the failure of the device 18, which is determined to have occurred in step S204.

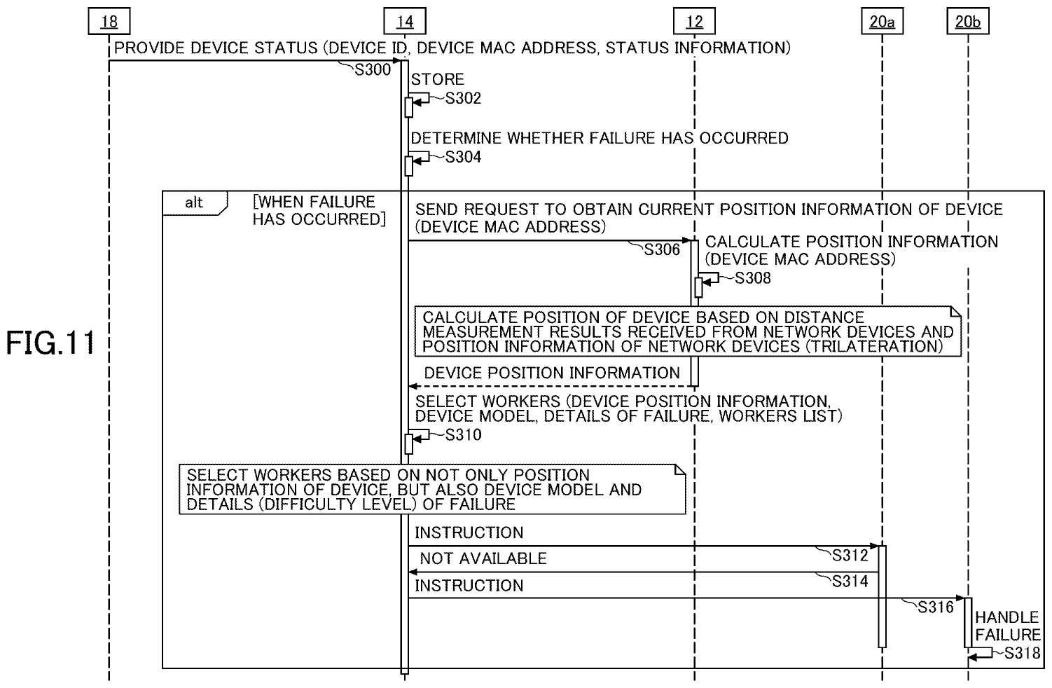

The process illustrated in the sequence diagram of FIG. 8 may be performed as illustrated in a sequence diagram of FIG. 11. FIG. 11 is a sequence diagram illustrating an example process performed by the information processing system according to the embodiment when a device failure occurs.

In step S300, the device 18 provides the device ID, the device MAC address, and status information to the device management apparatus 14. In step S302, the device management apparatus 14 associates the status information with the device ID and the device MAC address, provided by the device 18, and stores the status information associated with the device ID and the device MAC address.

In step S304, the device management apparatus 14 determines whether a failure has occurred in the device 18 based on the status information provided by the device 18. When the device management apparatus 14 determines that a failure has occurred in the device 18, the device management apparatus 14 sends, together with the device MAC address, a request to obtain position information of the device 18 to the network management apparatus 12 in step S306.

In step S308, the network management apparatus 12 uses trilateration (positioning based on three points) to calculate actual position information of the device 18, based on the distance measurement results received from the network devices 16a through 16c illustrated in FIG. 7 and position information of the network devices 16a through 16c, and sends a response to the device management apparatus 14.

In step S310, the device management apparatus 14 determines (selects) a plurality of workers who are to be responsible for the device 18, in which the failure has occurred, based on the actual position information of the device 18, position information of the workers (terminal devices 20), the model of the device 18, and the details of the failure, sets priorities for the respective workers, and creates a workers list. For example, the device management apparatus 14 determines a plurality of workers by taking into account the details (difficulty level) of the failure that has occurred and the types of failures that can be handled by the workers.

In step S312, the device management apparatus 14 transmits, to a terminal device 20a of a worker having the highest priority from among the workers in the workers list, an instruction indicating that the worker is to be responsible for the device 18. In the example of FIG. 11, in step S314, the terminal device 20a of the worker sends, to the device management apparatus 14, a response indicating that the worker is unavailable because the worker is currently responsible for another device 18 or the worker is to be responsible for another device 18.

Therefore, in step S316, the device management apparatus 14 transmits, to a terminal device 20b of a worker having the next highest priority from among the workers in the workers list, an instruction indicating that the worker is to be responsible for the device 18. In step S318, the worker of the terminal device 20b handles the failure of the device 18, which is determined to have occurred in step S304.

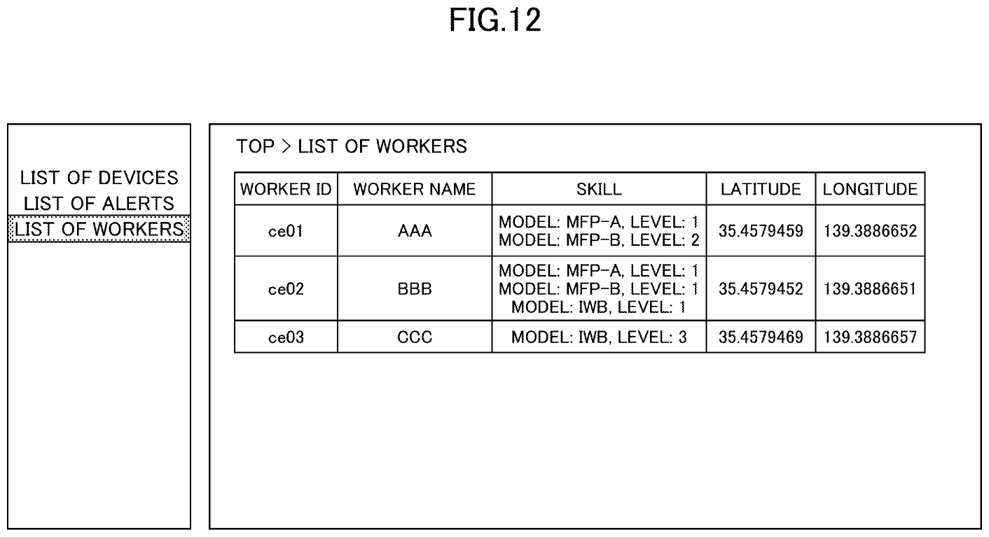

FIG. 12 is a diagram illustrating an example user interface of the management system according to the embodiment. Specifically, FIG. 12 depicts an example UI displaying a workers list. As illustrated in FIG. 12, position information (such as latitudes and longitudes) of workers is stored in association with worker IDs and skills of the workers. The skills of the workers are examples of the types of failures that can be handled by the workers.

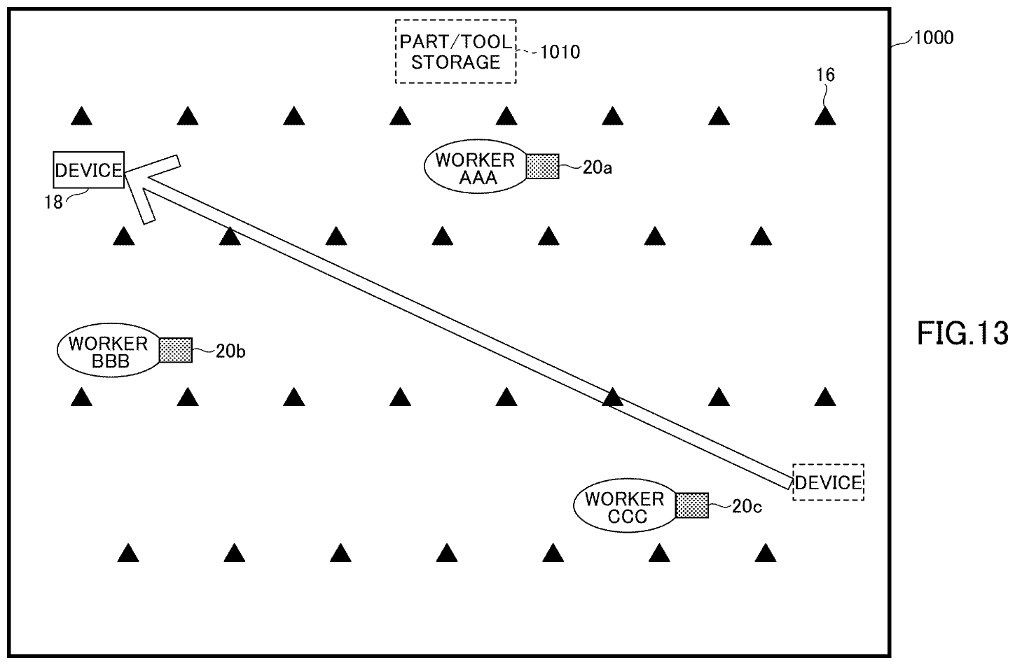

FIG. 13 is a diagram illustrating an example process performed by the information processing system according to the embodiment. Specifically, FIG. 13 depicts an example in which the information processing system according to the present embodiment is utilized to dispatch a worker to the device 18 in which a failure has occurred.

For example, a communicable area is formed by the three or more network devices 16 on an office floor 1000 of an office. Further, in the example of FIG. 13, the installation position of the device 18 is moved from the lower right to the upper left of the floor 1000. Further, in FIG. 13, a part/tool storage 1010 is provided on the floor 1000. Further, in FIG. 13, three workers AAA, BBB, and CCC are located on the floor 1000, and the workers have respective terminal devices 20a through 20c.

For example, in a conventional information processing system, if a failure has occurred in a device 18, the conventional information processing system would determine a worker based on position information of the device 18 before being moved, which is on the lower right side of the floor 1000. Therefore, the conventional information processing system would instruct the worker CCC located closest to the installation position of the device 18 before the device 18 is moved to handle the failure of the device 18. However, the worker CCC is not the worker closest to the actual installation position of the device 18.

Conversely, in the information processing system according to the present embodiment, if a failure has occurred in a device 18, the information processing system according to the present embodiment determines a worker based on position information of the device 18 after being moved, which is on the upper left side of the floor 1000. Therefore, the information processing system according to the present embodiment can instruct the worker BBB located closest to the installation position of the device 18 after the device 18 is moved to handle the failure of the device 18. Further, the information processing system according to the present embodiment may determine the position of the part/tool storage 1010, where parts and tools required for work are placed, based on the details of the failure of the device 18, and may take into account a route for obtaining parts and tools required for the work.

Accordingly, the information processing system according to the present embodiment can appropriately determine a worker who is to be responsible for a device 18 based on actual position information of the device 18. In the example of FIG. 13, it can be seen that the worker AAA can more efficiently move to the device 18 than, for example, the worker BBB located closest to the installation position of the device 18 by taking into account a route for obtaining parts and tools required for work.

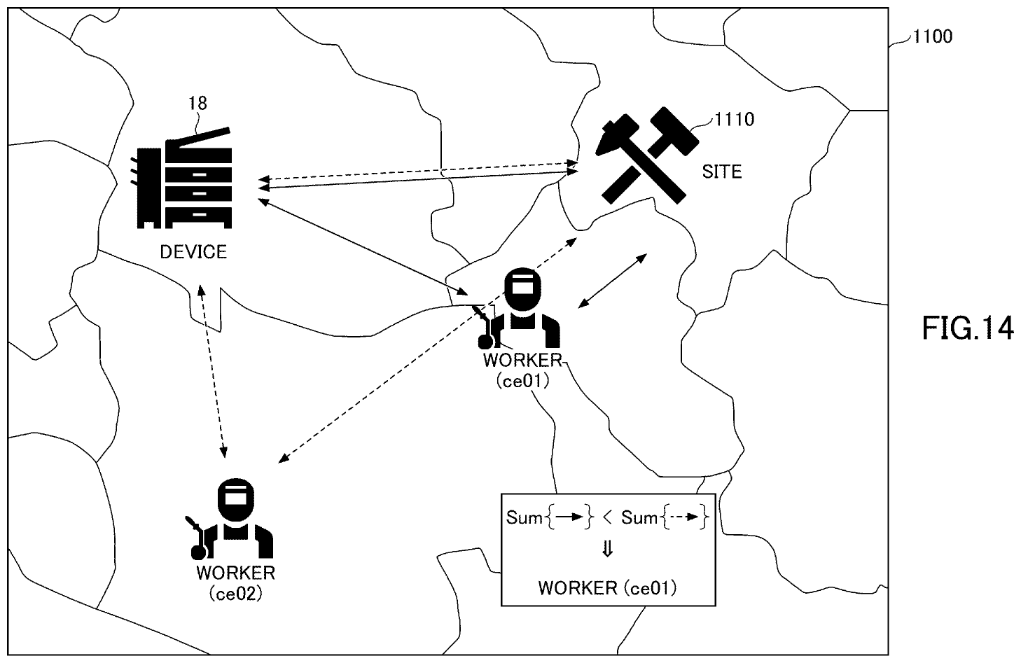

In FIG. 13, the floor 1000 of the office is depicted as an example. However, as illustrated in FIG. 14, the present invention can be applied to an area 1100 that that is wide and includes a branch office or a sales office of a company or the like, and a site 1110 where parts and tools required for work are placed.

FIG. 14 is a diagram illustrating an example process performed by the information processing system according to the embodiment. The area 1100 illustrated in FIG. 14 includes a branch office where a device 18 is installed, and the site 1110 where parts and tools required for work are placed. Further, two workers ce01 and ce02 are located in the area 1100.

In the area 1100 illustrated in FIG. 14, if a failure has occurred in the device 18, the information processing system according to the present embodiment can determine the location of the site 1110, where parts and tools required for work are placed, based on the details of the failure of the device 18, and select the worker ce01 who can efficiently move to the device 18 by taking into account a route for obtaining parts and tools required for work.

According to an embodiment of the present invention, a worker who is to be responsible for a device can be appropriately determined based on actual position information of the device.

The functions of the embodiments described above may be implemented by one or more processing circuits. As used herein, the “processing circuit” includes a processor programmed to cause software to execute the functions, such as a processor implemented by electronic circuitry, and an application-specific integrated circuit (ASIC), a digital signal processor (DSP), a field-programmable gate array (FPGA), and a conventional circuit module designed to execute the above-described functions.

Further, the group of apparatuses described in the above-described embodiments is merely representative of one of a plurality of computing environments for implementing the embodiments described herein.

Further, the present invention is not limited to above-described embodiments. Variations and modifications may be made to the described subject matter without departing from the scope of the present invention.

What is claimed is:

1. A management apparatus comprising:
a memory; and
a processor coupled to the memory and configured to
calculate position information of a device based on a distance measurement result with respect to the device, the distance measurement result being measured by each of three or more network devices that communicate with the device, and
determine a worker who is to be responsible for the device, based on position information of the worker and the calculated position information of the device, the position information of the worker being received from a terminal device that is assigned to the worker.

2. The management apparatus according to claim 1, wherein the processor is further configured to
receive status information provided by the device,
determine whether a failure has occurred in the device based on the status information, and
send, to the terminal device that is assigned to the worker who is determined to be responsible for the device, an instruction indicating that the worker is to be responsible for the device.

3. The management apparatus according to claim 2, wherein the processor is configured to
determine a plurality of workers who are to be responsible for the device,
set priorities for the respective workers,
send a first instruction to a first terminal device that is assigned to a first worker based on the priorities, and
send a second instruction to a second terminal device that is assigned to a second worker having a next priority, in response to receiving a response to the first instruction, the response indicating that the first worker is unavailable.

4. The management apparatus according to claim 2, wherein the processor is configured to determine the worker who is to be responsible for the device, based on one or both of a model of the device in which the failure has occurred and a detail of the failure in addition to the position information of the worker and the calculated position information of the device, the position information of the worker being received from the terminal device that is assigned to the worker.

5. The management apparatus according to claim 2, wherein the processor is configured to determine the worker who is to be responsible for the device, based on position information of one or both of a part and a tool to be used for the device in addition to the position information of the worker and the calculated position information of the device, the position information of the worker being received from the terminal device that is assigned to the worker.

6. A non-transitory recording medium storing a program for causing a computer to execute a process comprising:
calculating position information of a device based on a distance measurement result with respect to the device, the distance measurement result being measured by each of three or more network devices that communicate with the device; and
determining a worker who is to be responsible for the device, based on position information of the worker and the calculated position information of the device, the position information of the worker being received from a terminal device that is assigned to the worker.

7. A management method to be performed by a management system including a device management apparatus and a network management apparatus, the device management apparatus being configured to manage a device, and the network management apparatus being configured to manage three or more network devices that communicate with the device, the management method comprising:
calculating position information of the device based on a distance measurement result with respect to the device, the distance measurement result being measured by each of the three or more network devices that communicate with the device; and
determining a worker who is to be responsible for the device, based on position information of the worker and the calculated position information of the device, the position information of the worker being received from a terminal device that is assigned to the worker.
